(19) United States
(12) Patent Application Publication
(10) Pub. No.: US 2016/0191584 A1
(43) Pub. Date: Jun. 30, 2016

(54) SYNCHRONIZED VEHICLE MEDIA CONTENT SHARING MODERATION

(71) Applicant: Myine Electronics, Inc., Ferndale, MI (US)

(72) Inventors: Justin DICKOW, Royal Oak, MI (US); Scott SMEREKA, Warren, MI (US); Joey Ray GROVER, Madison Heights, MI (US); Joel J. FISCHER, Royal Oak, MI (US); Michael BURKE, Detroit, MI (US)

(21) Appl. No.: 14/586,319

(22) Filed: Dec. 30, 2014

(51) Int. Cl. H04L 29/06; H04L 29/08; H04W 4/00

(52) U.S. Cl. CPC H04L 65/4076; H04W 4/008; H04L 67/12

(57) ABSTRACT

A master media consumption device may stream media content to a plurality of slave media consumption devices for video playback, and may send playback status updates to the plurality of slave media consumption devices and the master media device to maintain synchronization of the audio and video playback. A device may identify as a master media device when connected to a computing platform of a vehicle, and as a media consumption device otherwise when the device is connected to the master media device. The device, when operating as the media consumption device, may display a video portion of an instance of media content; and when operating as the master media device, may provide an audio portion of the media content to the computing platform.

### TECHNICAL FIELD

Aspects of the disclosure relate to sharing, synchronizing, and moderating the playback of media content within a vehicle environment.

### BACKGROUND

In-vehicle rear seat entertainment systems may include video screen embedded in seat backs of front seats or folding down from the vehicle headliner. Such systems may allow a user to play a digital versatile disk (DVD) through the vehicle sound system and the embedded screens. In some cases, systems may allow a user to playback content from solid state drives or other storage media. Other rear seat entertainment systems may include aftermarket units that attach to the front or middle row headrests. Rather than using such systems, passengers may simply watch content using their smartphones, tablets, or other mobile devices.

### SUMMARY

In a first illustrative embodiment, a system includes a master media consumption device, configured to stream media content to a plurality of slave media consumption devices for video playback; provide a media content playback status to a computing platform of a vehicle for display via the vehicle; and send playback status updates to the plurality of the slave media consumption devices to maintain synchronization of the playback.

In a second illustrative embodiment, a non-transitory computer-readable medium embodies instructions that, when executed by a processor of a mobile device, are configured to cause the mobile device to identify the mobile device in a media sharing system as a master media device when connected to a computing platform of a vehicle, as a master media consumption device when streaming media content over an in-vehicle network, and as a slave media consumption device when receiving the media content over the in-vehicle network; when operating as the master media device, provide a media content playback status to the computing platform for in-vehicle display; and when operating as the slave media consumption device, periodically poll the master media consumption device for the playback status to synchronize playback of the media content over the in-vehicle network.

In a third illustrative embodiment, a computer-implemented method includes identify a role of a mobile device in a media sharing system as a master media device when the device is connected to a computing platform of a vehicle, and otherwise as a media consumption device when the device is connected to the master media device over an in-vehicle network; when operating as the master media device, providing an audio portion of an instance of media content to the computing platform; and when operating as the media consumption device, displaying a video portion of the instance of media content received over the in-vehicle network.

### BRIEF DESCRIPTION OF THE DRAWINGS

FIG. 1 illustrates an example diagram of a system that may be used to provide telematics services to a vehicle;

FIG. 2 is an illustrative example of a system configured for synchronized presentation of media content in the vehicle;

FIG. 3 is an illustrative example of a portion of the system configured for playing media content stored remotely on a media server;

FIG. 4 illustrates an example data flow for the synchronized presentation of media content in the vehicle; and

FIG. 5 illustrates an example process for playing back a selected instance of media content.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Rear seat entertainment systems may be relatively low in features and unfamiliar compared to modern tablet computing devices. Moreover, in-vehicle systems may be limited in configurability as compared to tablet computing devices. In many cases, in-vehicle entertainment systems may lack connectivity to access a user's media content stored on his or her mobile devices or accessible by the mobile devices from a remote server.

Rather than providing consumers with another way of consuming media content (such as by including rear seat entertainment packages in vehicles), an improved vehicle media content system may allow vehicle occupants to consume media together, on their own media consumption devices (e.g., tablet computing devices, smartphones, etc.), where the presentation of media content is mediated (if necessary) through a mobile device of the driver that is in communication with a computing platform of the vehicle. Further aspects of the vehicle media content system are discussed in detail below.

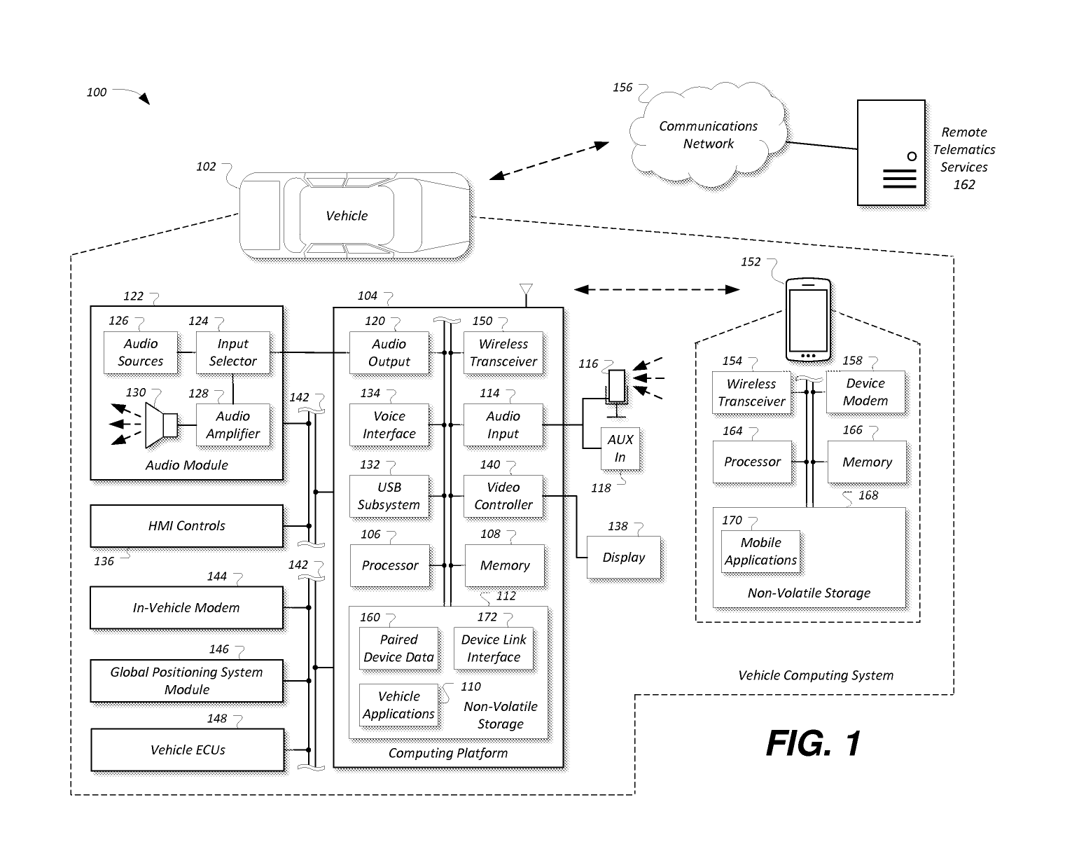

FIG. 1 illustrates an example diagram of a system 100 that may be used to provide telematics services to a vehicle 102. The vehicle 102 may include various types of passenger vehicle, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory (e. g., tangible) medium that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a wired jack, such as a stereo input, or a wireless input, such as a BLUETOOTH audio connection. In some examples, the audio input 114 may be configure to provide audio processing capabilities, such as pre-amplification of low-level signals, and conversion of analog inputs into digital data for processing by the processor 106.

The computing platform 104 may also provide one or more audio outputs 120 to an input of the audio playback functionality of the audio module 122. In other examples, the computing platform 104 may provide audio output to the occupants through use of one or more dedicated speakers (not illustrated). The audio module 122 may include an input selector 124 configured to provide audio content from a selected audio source 126 to an audio amplifier 128 for playback through vehicle speakers 130. The audio sources 126 may include, as some examples, decoded amplitude modulated (AM) or frequency modulated (FM) radio signals, and compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to a grammar of available commands, and voice prompt generation for output via the audio module 122. In some cases, the system may be configured to temporarily mute or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke computing platform 104 functions (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as an vehicle modem 144 (which may not be present in some configurations), a global positioning system (GPS) module 146 configured to provide current vehicle 102 location and heading information, and various vehicle ECUs 148 configured to provide other types of information regarding the systems of the vehicle 102. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142, and the vehicle modem 144, GPS module 146, and vehicle ECUs 148 may communicate with the computing platform 104 over a second in-vehicle network 142. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention.

When a mobile device 152 that supports network connectivity is paired with the computing platform 104, the mobile device 152 may allow the computing platform 104 to use the network connectivity of the device modem 158 to communicate over the communications network 156 with the remote telematics services 162. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 via the wireless transceiver 154 and with the remote telematics services 162 or other network services via the device modem 158. The computing platform 104 may also include a device link interface 172 to facilitate the integration of functionality of the mobile applications 170 into the grammar of commands available via the voice interface 134. The device link interfaced 172 may also provide the mobile applications 170 with access to vehicle information available to the computing platform 104 via the in-vehicle networks 142. An example of a device link interface 172 may be the SYNC APPLINK component of the SYNC system provided by The Ford Motor Company of Dearborn, Mich.

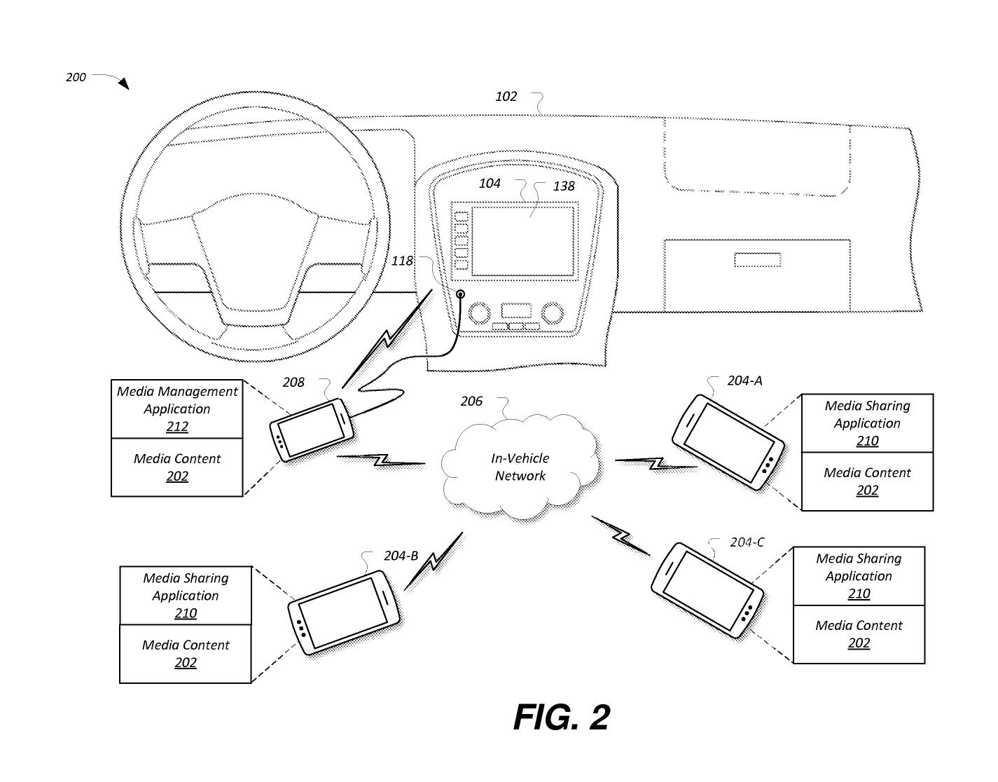

FIG. 2 is an illustrative example of a system 200 configured for synchronized presentation of media content 202 in the vehicle 102. As illustrated, the vehicle 102 include a display 138 mounted in a HMI control area between the driver and front passenger seats. The vehicle 102 also includes a plurality of networked media consumption devices 204-A through 204-C (collectively 204) configured to display media content 202 and communicate via a local network 206. The vehicle 102 may also include a master media device 208 in communication with the computing platform 104 and with the networked media consumption devices 204. To facilitate the sharing and synchronized presentation of media content 202 within the vehicle 102, a media sharing application 210 may be installed to the media consumption devices 204, and a media management application 212 may be installed to the master media device 208. It should be noted that this configuration is merely an example, and systems having more or fewer media consumption devices 204 or varied device layouts are possible.

Media content 202 may include, for example, music, television, movies, commercials, or other types of content. In many cases, the media content 202 may include both video and audio components, but in some cases an instance of media content 202 may include only audio or only video. To facilitate the identification of the media content 202, instances of media content 202 may further include or otherwise be associated with metadata information, such as name, artist, title, track number, duration, rating, date recorded and date downloaded, as some non-limiting examples.

The media consumption devices 204 may include various types of mobile device 152 (e.g., tablet computing devices, smartphones, etc.) configured to display media content 202 and to communicate with one another over the local network 206. As some examples, the local network 206 may include communications via Bluetooth low energy (BLE) and/or a Wi-Fi network. In an example, a BLE local network 206 may be utilized for control of the devices, and a Wi-Fi network may be used for transfer and time synchronization of media content 202. The media consumption devices 204 may be further configured to store instances of media content 202 for playback in non-volatile storage 168 of the media consumption devices 204, or in one or more other memories of the media consumption devices 204. In other cases the media content 202 may be streaming content that may be downloaded as it is being presented.

The master media device 208 may include various types of mobile device 152 configured to be paired with the vehicle platform 104. The master media device 208 may be configured to communicate with the vehicle platform 104 in various ways, such as via a wireless connection between the wireless transceiver 150 of the computing platform 104 and the wireless transceiver 154 of the master media device 208, or via a wired connection between the master media device 208 and the USB subsystem 132 of the computing platform 104. The master media device 208 may be further configured to communicate with the media consumption devices 204, such as over the local network 206. Accordingly, the master media device 208 may function as a bridge between the media consumption devices 204 and the computing platform 104 of the vehicle 102.

The media sharing application 210 may be installed to the media consumption devices 204, and may be configured to allow the media consumption devices 204 to perform synchronized playback and streaming of media content 202, as well as facilitating the communications with the master media device 208. The media sharing application 210 may be further configured to arbitrate which of the media consumption devices 204 is to be the master media consumption device 204, and which media consumption devices 204 are to be slave media consumption devices 204. The master media consumption device 204 may be configured to provide information such as current time and current playback position over the local network 206 to the other slave media consumption devices 204 to facilitate the synchronized playback of media content 202. The slave media consumption devices 204 may be configured to receive the information over the local network 206 from the master media consumption device 204, and maintain synchronization of the media content 202 being played back.

The media management application 212 may be installed to the master media device 208, and may be configured to allow the master media device 208 to be controlled by the vehicle 102 as well as to facilities the presentation of information to the driver by way of the HMI of the vehicle 102. It should be noted that in some cases, the media sharing application 210 and the media management application 212 may be implemented in same application, where the function of the application may depend on whether the device is connected to the vehicle platform 104 as the master media device 208 or is connected to the master media device 208 as a media consumption device 204.

When a plurality of mobile device 152 wish to enter a media session, the mobile devices 152 may negotiate which mobile device 152 is to be the master media device 208, and which mobile devices 152 are to be media consumption devices 204. In an example, the mobile device 152 that is paired with the vehicle platform 104 (e.g., the driver's device) may be deemed to be the master media device 208, and the master media consumption device 204 which has the local media content 202 or that is streaming the media content 202 to other devices may be deemed the master media consumption device 204. The other media consumption devices 204 may be deemed to be slave media consumption devices 204.

The media management application 212 may utilize the vehicle platform 104 to provide for command and control of a media sharing application 210 installed to the driver's smartphone or other mobile device. In an example, the media management application 212 may be configured to receive play, pause, fast-forward, rewind, seek-to-time (e.g., a new play location), and media content 202 selection commands from the vehicle platform 104. For instance, these commands may be provided from the vehicle platform 104 to the media management application 212 responsive to user input to the vehicle HMI controls 136. Using the local network 206 (e.g., via BLE or some other transport), the master media device 208 may send commands to the master media consumption device 204-A, enabling the master media device 208 to, for example, select, play, or pause media content 202 on the media consumption devices 204.

The master media device 208 may be configured to communicate with and control the master media consumption device 204. In the case of BLE as the local network 206, the master media device 208, for example, may be configured to project playback commands to the master media consumption device 204 via BLE characteristics. The commands may be, as some possibilities, a play event, a pause event, a buffering event, or a seek-to-time event. When those commands are written on the master media consumption device 204 by the master media device 208, the master media consumption device 204 alters its playback. Moreover, the synchronizing slave media consumption devices 204 note the changes by the master media consumption device 204 and alter their playback to correspond to that of the master media consumption device 204. Accordingly, the slave media consumption devices 204 may also respond to the identified event.

In an example, the master media consumption device 204 may provide information to the slave media consumption devices 204 to identify an elapsed time of the media content 202 (e.g., a current elapsed playback time or playback position). The slave media consumption devices 204 may accordingly be configured to receive the information (e.g., read the BLE characteristics, receive messages via Wi-Fi, poll the master media consumption device 204 for current playback status time and state information (e.g., playing a specified instance of media content 202, paused, stopped, unknown state), etc.). Based on the received information, the slave media consumption devices 204 may be able to synchronize playback of the media content 202 (e.g., performed via video and optionally also audio capabilities of the slave media consumption devices 204) with the master media consumption devices 204.

For instance, slave media consumption devices 204 may request a current elapsed time from the master media consumption device 204, and receive the elapsed time in a message in response. The slave media consumption devices 204 may then use the received elapsed time to ensure that the playback of the media content 202 is sufficiently synchronized with the master media consumption device 204.

To avoid issues with synchronization of the clocks between the media consumption devices 204, the slave media consumption devices 204 may correct the received elapsed time value for latency using the round-trip delay. For example, the slave media consumption devices 204 may estimate the one-way latency with the master media consumption device 204 as half of the round-trip latency time between sending the request and receiving the response. The slave media consumption devices 204 may also improve the estimate of round-trip latency time by subtracting an estimated amount of processing time from the round-trip time before dividing the delay by two (e.g., to account for processing time on the master media consumption device 204 and on the slave media consumption device 204). Thus, to determine the estimated elapsed time corrected for latency time since the value was provided, the slave media consumption device 204 may add the estimated one-way latency value to the received current elapsed time. In some cases, the slave media consumption devices 204 may be configured to disregard a playback status if the calculated latency exceeds a predetermined maximum threshold value (i.e., where the confidence in the master media consumption device 204 playback time is determined to be too low).

To provide for synchronization, the slave media consumption device 204 may identify how far off its current playback time is from the current elapsed time, such as by subtracting the corrected elapsed time value from its current elapsed time value of the playback. If the differential in time exceeds a predefined threshold amount of time, the slave media consumption device 204 may be configured to correct its current playback position in accordance with the received elapsed time value. If the differential is less than the threshold, then the slave media consumption device 204 may continue the playback as-is. Accordingly, the slave media consumption devices 204 may adjust their playback positions when they become sufficiently unsynchronized from the master media consumption device 204, while also avoiding numerous distracting positional adjustments for minor offsets in playback.

In another example, the master media device 208 may consume a characteristic (e.g., a pause event), and may provide to the display 138 of the head unit an indication of the current pause state.

In addition to providing information to the slave media consumption devices 204, the master media consumption device 204 may be further configured to stream media content 202 to be played back to the slave media consumption devices 204 (e.g., if the media content 202 is not already available to the slave media consumption devices 204). In an example, the master media consumption device 204 may utilize an HTTP server to serve the video media content 202 to the slave media consumption devices 204 over a Wi-Fi local network 206 or other network available within the vehicle 102 with sufficient bandwidth to support the transfer of the media content 202. If the media content 202 includes audio, the master media consumption device 204 may be further configured to provide at least the audio portion of the media content 202 to the computing platform 104 for presentation via the audio module 122 or other audio playback functionality of the vehicle 102.

The master media consumption device 204 may be configured to serve media content 202 that is stored local to the master media consumption device 204. In another example, the master media consumption device 204 may be configured to stream and serve media content that is stored remote from the media consumption devices 204 within the vehicle 102. In some cases, an instance of media content 202 may be selected for playback that is not stored local to or streamed by the current master media consumption device 204. In such an example, which media consumption device 204 is deemed to be the master media consumption device 204 may be renegotiated to be the media consumption device 204 storing or streaming the instance of media content 202 to be played back.

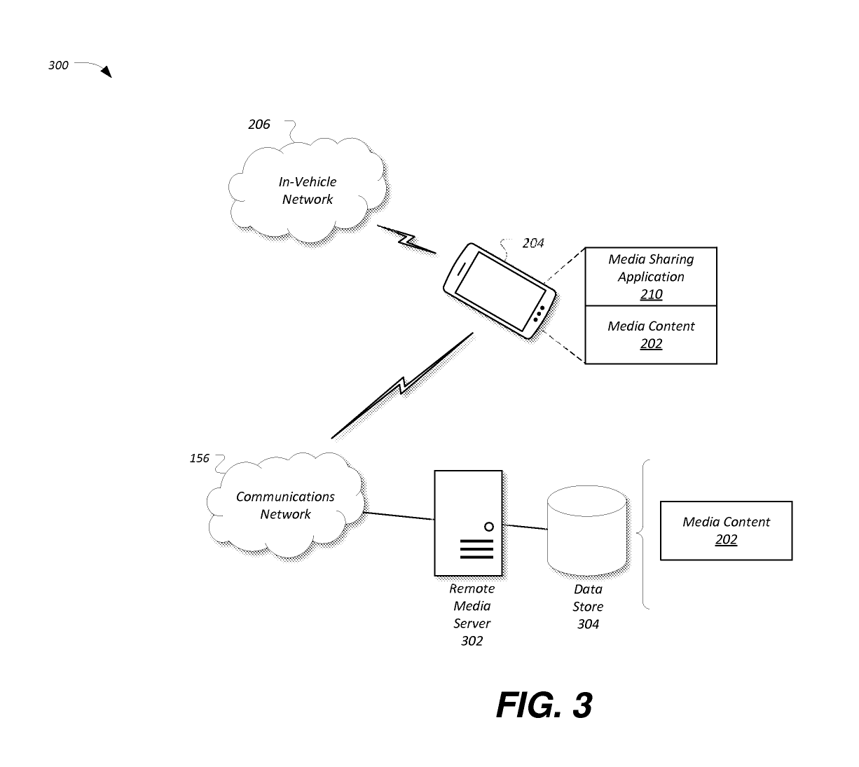

FIG. 3 is an illustrative example 300 of a portion of the system 200 configured for playing media content 202 stored remotely on a media server 302. As shown, a media consumption device 204 (such as one or more of the media consumption device 204-A through 204-C) may be configured to stream or download instances of media content 202 for playback from the media server 302. In an example, the media consumption device 204 may be configured to request the instances of media content 202 over the communications network 156 using device modems 158 or other networking features of the media consumption devices 204. The media server 302 may, for example, be configured to access a data store 304 maintaining media content 202 instances, and provide the requested media content 202 to the requesting media consumption device 204. Accordingly, the media consumption devices 204 may be able to access and utilize media content 202, whether stored local to or remote from the media consumption devices 204.

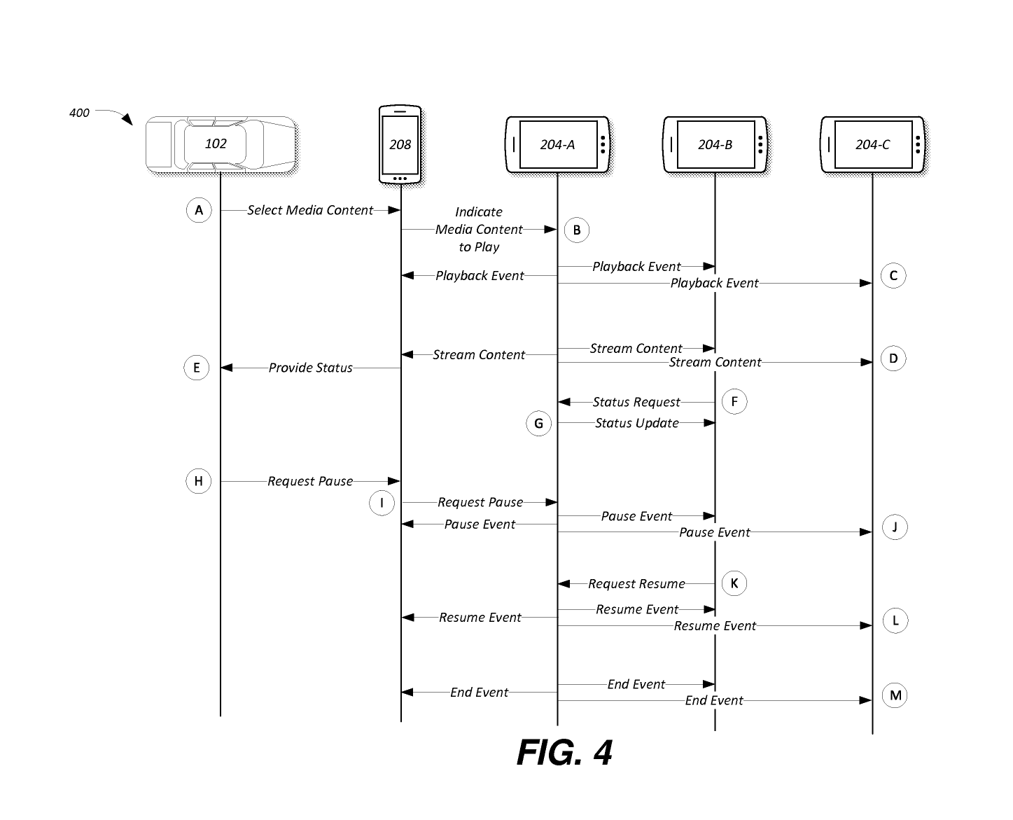

FIG. 4 illustrates an example data flow 400 for the synchronized presentation of media content 202 in the vehicle 102. The data flow 400 may be performed, in an example, by the computing platform 104, master media device 208, and media consumption device 204 of the system 200 described above. The data flow 400 may be initiated, for instance, by selection of an instance of media content 202 for playback.

At time index (A), the computing platform 104 provides a request for playback of the instance of media content 202 to the master media device 208. As one possibility, a driver or other occupant of the vehicle 102 may utilize the HMI of the vehicle 102 to select an instance of media content 202 for playback, such as by selecting an instance of media content 202 from a display 138 of the computing platform 104 or by a voice command to the computing platform 104 requesting playback of the instance of media content 202. As another possibility, the driver or other occupant of the vehicle 102 may utilize the HMI of one of the media consumption device 204 to select the instance of media content 202 for playback. Responsive to the selection, the computing platform 104 provides the request to the master media device 208.

At time index (B), the master media device 208 indicates to the master media consumption device 204 the instance of media content 202 to be played. In an example, the master media device 208 may project a BLE characteristic that indicates a playback event of the identified instance of media content 202.

At time index (C), the master media consumption device 204 sends a playback event to the slave media consumption devices 204 indicating the instance of media content 202 to be played. In an example, the master media consumption device 204 may send the playback event over Wi-Fi to the slave media consumption devices 204. Responsive to the event, the media consumption device 204 may send a request (e.g., an HTTP request) to receive the instance of media content 202 via a stream from a server (e.g., an HTTP server) of master media consumption device 204.

At time index (D), the master media consumption device 204 begins to stream playback of the instance of media content 202. In an example, the master media consumption device 204 may utilize its server to serve the media content 202 to the slave media consumption devices 204 and the master media device 208 over a Wi-Fi local network 206 or other network available within the vehicle 102 worth sufficient bandwidth to support the transfer of the media content 202.

At time index (E), the master media device 208 provides the current playback status of the streamed instance of media content 202 to the computing platform 104. For example, the master media device 208 may periodically poll the master media consumption device 204 for current playback status information, and may provide the status information to the computing platform 104 for display via the head unit or other displays 138 of the vehicle 102. In some cases, the master media device 208 may receive the streamed media content from the master media consumption device 204 (or only the audio portion), and provide the audio to the computing platform 104, such as via the auxiliary audio input 118. In other cases, the master media consumption device 204 may provide the audio to the computing platform 104, or may play back the audio itself.

At time index (F), the master media consumption device 204-A receives a playback status request from the slave media consumption device 204-B for the current playback position/elapsed time and playback state. The slave media consumption devices 204 may be configured to send these requests according to a polling interval, such as every four-hundred milliseconds.

At time index (G), the master media consumption device 204-A sends a playback status update to the slave media consumption device 204-B indicating the current playback position of the instance of media content 202 being played. In an example, the master media consumption device 204-A may include a time index of the current playback position of the identified instance of media content 202 (e.g., elapsed time) in the playback status updates responsive to requests from the slave media consumption devices 204 (only one request shown in FIG. 4 for clarity). For instance, if a slave media consumption device 204 determines that it is too far behind in playback (e.g., due to a slow network connection), the slave media consumption device 204 may perform a re-buffering of the media content 202 streamed from the master media consumption device 204-A and may rejoin the playback of the media content 202 at a later time index. As another possibility, a new slave media consumption device 204 adding to the system 200 may be able to join an existing playback of media content 202 by receiving the current playback event characteristics and the most recent time index event. It should be noted that while the playback status event is only illustrated once in the data flow 400 and only from the slave media consumption device 204-B, in many cases the time index event may be requested by each of the slave media consumption device 204 and the master media device 208 (e.g., every two-hundred milliseconds, every three-hundred milliseconds, every second, every three seconds, etc.) and responded to by the master media consumption device 204-A responsive to the playback status requests to allow the slave media consumption devices 204 to continually synchronize their playback of the streamed instance of media content 202.

At time index (H), the computing platform 104 provides a pause request to the master media device 208 to halt to the playback of the instance of media content 202. As one possibility, the computing platform 104 may determine or may be informed of a road condition in which the driver may become distracted. As another possibility, the computing platform 104 may determine that a call is incoming to the master media device 208 or the vehicle 102. As yet a further possibility, a driver or other occupant of the vehicle 102 may utilize the HMI of the vehicle 102 to request that the instance of media content 202 be paused (e.g., via a voice command, via the display 138, etc.) Responsive to the determination or user input, the computing platform 104 may provide the pause request to the master media device 208.

At time index (I), the master media device 208 indicates to the master media consumption device 204 to pause the instance of media content 202 being played. In an example, the master media device 208 may project a BLE characteristic that indicates a pause event. Accordingly, the slave media consumption device 204 may note the new playback status in response to the next response they receive of the polled playback state as described above with respect to time indexes (F) and (G).

At time index (J), the master media consumption device 204 sends a pause event to the slave media consumption devices 204 requesting a halt to the playback of the instance of media content 202. In an example, the master media consumption device 204 may project a BLE characteristic that indicates a pause event of the instance of media content 202.

At time index (K), one of the slave media consumption devices 204 provides a request to the master media device 208 to resume the playback of the instance of media content 202. In an example, a user of the slave media consumption devices 204-B may select a resume function via the HMI of the slave media consumption devices 204-B, and the slave media consumption devices 204-B may provide the request to the master media device 208 to resume the playback of the instance of media content 202.

At time index (L), the master media consumption device 204 sends a resume event to the slave media consumption devices 204 requesting resumption of the playback of the instance of media content 202. In an example, the master media consumption device 204 may project a BLE characteristic that indicates a resume event of the instance of media content 202. While not shown, in some examples the master media consumption device 204 may request that the master media device 208 confirm with the computing platform 104 that the media content 202 may be resumed before sending the resume event to the slave media consumption devices 204.

At time index (M), the master media consumption device 204 sends an end event to the slave media consumption devices 204 indicating the termination of playback of the instance of media content 202. In an example, the master media consumption device 204 may determine that the end of the instance of media content 202 is reached, and may project a BLE characteristic that indicates an end event of the instance of media content 202.

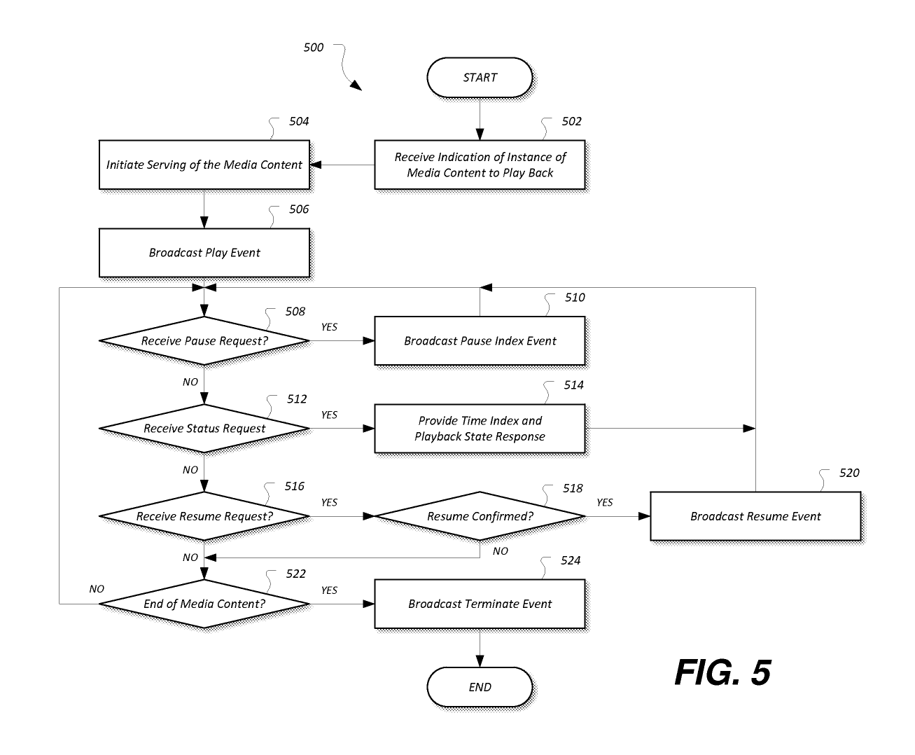

FIG. 5 illustrates an example process 500 for playing back a selected instance of media content 202. As with the data flow 400, the process 500 may be performed by elements of the system 200 described in detail above.

At operation 502, the master media consumption device 204 receives an indication of an instance of media content 202 to play back. In an example, the master media consumption device 204 may receive the indication from the master media device 208 according to HMI input to the computing platform 104. In another example, the master media consumption device 204 may receive the indication one of the slave media consumption devices 204 (e.g., via the local network 206), or from a user of the master media consumption device 204 itself.

At operation 504, the master media consumption device 204 initiate serving of the instance of media content 202. In an example, the master media consumption device 204 may utilize an HTTP server to serve the video media content 202 to the slave media consumption devices 204 over a Wi-Fi local network 206 or other network available within the vehicle 102 with sufficient bandwidth to support the transfer of the media content 202. In some cases, the instance of media content 202 to play back may be stored remotely, and the master media consumption device 204 may be configured to request the instance of media content 202 from the media server 302 over the communications network 156.

At operation 506, the master media consumption device 204 broadcasts a play event. In an example, the master media device 208 may project a BLE characteristic that indicates the playback event of the identified instance of media content 202.

At operation 508, the master media consumption device 204 determines whether a pause event is identified. In an example, the master media consumption device 204 may receive a pause request from one of the slave media consumption devices 204, or from a user of the master media consumption device 204. In another example, the master media consumption device 204 may receive a pause event from the computing platform 104 via the master media device 208. If a pause event is identified, control passes to operation 510. Otherwise, control passes to operation 512.

At operation 510, the master media consumption device 204 broadcasts the pause event. In an example, the master media device 208 may project a BLE characteristic that indicates the pause event.

At operation 512, the master media consumption device 204 determines whether a playback status request has been received. In an example, the master media consumption device 204 may receive a request from a slave media consumption device 204 or the master media device 208 require. If the playback status event is identified, control passes to operation 514. Otherwise, control passes to operation 516.

At operation 514, the master media consumption device 204 sends the playback status response. In an example, the master media device 208 may send the response including the current elapsed playback time of the instance of media content 202.

At operation 516, the master media consumption device 204 determines whether a resume event is identified. In an example, the master media consumption device 204 may receive a resume request from one of the slave media consumption devices 204, or from a user of the master media consumption device 204. In another example, the master media consumption device 204 may receive a resume event from the computing platform 104 via the master media device 208. If the resume event is identified, control passes to operation 518. Otherwise, control passes to operation 522.

At operation 518, the master media consumption device 204 determines whether the resume event is confirmed. If the master media consumption device 204 receives the resume event from the computing platform 104 via the master media device 208, then no further verification may be required, and control passes to operation 520. Otherwise, the master media consumption device 204 may request the master media device 208 to confirm with the computing platform 104 that it is permissible to resume the playback. If playback is confirmed to continue, control passes to operation 520. Otherwise, control passes to operation 522.

At operation 520, the master media consumption device 204 broadcasts the resume event. In an example, the master media device 208 may project a BLE characteristic that indicates the resume event. In another example, the resume event may be noted by the slave media consumption devices 204 upon polling for the playback status.

At operation 522, the master media consumption device 204 determines whether a terminate event is identified. In an example, the master media consumption device 204 may receive a terminate request from one of the slave media consumption devices 204, or from a user of the master media consumption device 204. In another example, the master media consumption device 204 may receive a terminate event from the computing platform 104 via the master media device 208. In yet a further example, the master media consumption device 204 may identify that the instance of media content 202 has played to the end. If the terminate event is identified, control passes to operation 524. Otherwise, control passes to operation 506.

At operation 524, the master media consumption device 204 broadcasts the terminate event. In an example, the master media device 208 may project a BLE characteristic that indicates the terminate event. The master media device 208 may also discontinue serving of the instance of media content 202. After operation 524, the process 500 ends.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a master media consumption device, configured to
stream media content to a plurality of slave media consumption devices for video playback;
provide a media content playback status to a computing platform of a vehicle for display via the vehicle; and
send playback status updates to the plurality of the slave media consumption devices to maintain synchronization of the playback.

2. The system of claim 1, wherein the master media consumption device is further configured to:
receive a playback status request from one of the slave media consumption devices polling the master media consumption device; and
responsive to the request, send a playback status update to the one of the slave media consumption devices including a current playback position of the media content.

3. The system of claim 2, wherein the one of the slave media consumption devices is further configured to:
adjust the current playback position according to a round-trip delay time between the playback status request and the playback status update;
compare a device playback position of the media content to the current playback position, as adjusted; and
update a device playback position of the media content when the current playback position, as adjusted, is greater than a minimum threshold difference within which playback position variance is acceptable and less than a maximum threshold difference indicative of an unreliable playback status update.

4. The system of claim 1, wherein one of the master media consumption device or the slave media consumption devices is further configured to retrieve the media content from a remote media server.

5. The system of claim 1, wherein the master media consumption device is further configured to utilize a hypertext transfer protocol server to serve the media content over a Wi-Fi in-vehicle network.

6. The system of claim 1, wherein the master media consumption device is further configured to:
receive a pause request from the computing platform via the master media device; and
responsive to receipt of the pause request, set the playback status to pause to cause the plurality of slave media consumption devices and the master media device to discontinue the playback.

7. The system of claim 6, wherein the pause request is received based on at least one of an incoming call and identification by the vehicle of a driving condition requiring halting the playback.

8. A non-transitory computer-readable medium embodying instructions that, when executed by a processor of a mobile device, are configured to cause the mobile device to:
identify the mobile device in a media sharing system as a master media device when connected to a computing platform of a vehicle, as a master media consumption device when streaming media content over an in-vehicle network, and as a slave media consumption device when receiving the media content over the in-vehicle network;
when operating as the master media device, provide a media content playback status to the computing platform for in-vehicle display; and
when operating as the slave media consumption device, periodically poll the master media consumption device for the playback status to synchronize playback of the media content over the in-vehicle network.

9. The medium of claim 8, further embodying instructions configured to cause the device to, when operating as the master media device, receive a pause request from the computing platform, and send the pause request to the media consumption device to cause the media consumption device to pause video playback.

10. The medium of claim 9, wherein the pause request is received based on at least one of an incoming call and identification by the vehicle of a driving condition requiring halting the playback.

11. The medium of claim 9, further embodying instructions configured to cause the device to send the pause request as a projected Bluetooth low energy characteristic.

12. The medium of claim 8, further embodying instructions configured to cause the device to, when operating as the master media consumption device, send playback status updates to other devices in the media sharing system to maintain synchronization of the playback.

13. The medium of claim 12, wherein the playback status updates include a current playback position and a current playback status indicative of whether playback is active.

14. The medium of claim 8, further embodying instructions configured to cause the device to, when operating as the master media consumption device, retrieve the media content from a remote media server and serve the media content to other devices in the media sharing system over a local vehicle network.

15. A computer-implemented method comprising:
identifying a mobile device in a media sharing system as a master media device when connected to a computing platform of a vehicle, as a master media consumption device when streaming media content, and as a slave media consumption device when receiving the media content over an in-vehicle network; and
when operating as the master media device, providing a media content playback status to the computing platform for in-vehicle display.

16. The method of claim 15, further comprising, when operating as the master media device, receive a pause request from the computing platform, and send the pause request to the media consumption device to cause the media consumption device to pause video playback.

17. The method of claim 16, further comprising receiving the pause request based on at least one of an incoming call and identification by the vehicle of a driving condition requiring halting the playback.

18. The method of claim 16, further comprising sending the pause request as a projected Bluetooth low energy characteristic.

19. The method of claim 15, further comprising, when operating as the master media consumption device, sending playback status updates to other devices in the media sharing system to maintain synchronization of playback of the media content, wherein the playback status updates include a current playback position.

20. The method of claim 15, further comprising, when operating as the master media consumption device, retrieving the media content from a remote media server and serving the media content to other devices in the media sharing system over a local vehicle network.
